(19) United States
(12) Patent Application Publication
(10) Pub. No.: US 2023/0229982 A1
(43) Pub. Date: Jul. 20, 2023

(54) GRAVITY BASED ROUTING OPTIMIZATION FOR GOODS OR DATA

(71) Applicant: International Business Machines Corporation, Armonk, NY (US)

(72) Inventors: Aaron K. Baughman, Cary, NC (US); Shikhar Kwatra, San Jose, CA (US); Denise A. Sarkor, Smyrna, GA (US); Lauren J. Shoemaker, Sandy Springs, GA (US)

(73) Assignee: International Business Machines Corporation, Armonk, NY (US)

(21) Appl. No.: 17/576,439

(22) Filed: Jan. 14, 2022

(51) Int. Cl. G06Q 10/04; G06Q 10/06; G06F 40/279

(52) U.S. Cl. CPC G06Q 10/047; G06Q 10/06315; G06F 40/279

(57) ABSTRACT

From a first set of natural language documents describing a demand for a movable physical item, a set of demand features is extracted. From a second set of natural language documents describing a supply of the movable physical item, a set of supply features is extracted. A correlation quantifying a relationship between the set of demand features and the set of supply features is computed. Using the correlation and the correlation trend, an attraction between the set of demand features and the set of supply features is modeled as a gravitational force. Using a routing determined according to the attraction, the movable physical item is caused to be transported.

### BACKGROUND

The present invention relates generally to a method, system, and computer program product for routing optimization. More particularly, the present invention relates to a method, system, and computer program product for gravity based routing optimization for goods or data.

Goods are physical items that are movable. A supply chain is a system of entities (including people and organizations), activities, data, and resources involved in creating goods from source materials and moving the goods from a creation point (e.g. a factory or a farm) to a consumer.

A content delivery network (CDN) or content distribution network is a geographically distributed network of data servers, used to improve data availability by locating content in close proximity, within a network, to a consumer of the content. Locating content close to a content consumer minimizes the distance the content travels over links in the network, improving content delivery speed and freeing network bandwidth for another use.

Thus, a supply chain and a CDN are both use cases of routing optimization, in which one or more of a source, destination, the best route between the source and destination, and the timing of the routing are selected and used to move goods or data. The optimization is governed by one or more constraints. For a supply chain, some examples of constraints are the time elapsed for the route, the number of segments in the route, and an expected seasonal demand cycle. For a CDN, one example of constraints are the time elapsed from when data is requested until the requested data is delivered.

Another use case of routing optimization is in routing money from one place to another, in which the best route is the route most similar to a goal or interest of a source of the money. For example, a user intending to make a financial investment (e.g. buying a stock or bond) would like to select the investment most similar to the investor's goal in making the investment (e.g. saving for retirement, or investing in a new technology startup). Similarly, a user intending to make a charitable contribution would like to select the charity most similar to the investor's goals or interests to receive the contribution.

### SUMMARY

The illustrative embodiments provide a method, system, and computer program product. An embodiment includes a method that extracts, from a first set of natural language documents describing a demand for a movable physical item, a set of demand features. An embodiment extracts, from a second set of natural language documents describing a supply of the movable physical item, a set of supply features. An embodiment computes a correlation between the set of demand features and the set of supply features, the correlation quantifying a relationship between the set of demand features and the set of supply features. An embodiment computes a correlation trend corresponding to the correlation, the correlation trend quantifying a variation in the relationship between the set of demand features and the set of supply features over a time period. An embodiment models, as a gravitational force, using the correlation and the correlation trend, an attraction between the set of demand features and the set of supply features. An embodiment causes transporting of, using a routing determined according to the attraction, the movable physical item.

An embodiment includes a computer usable program product. The computer usable program product includes one or more computer-readable storage devices, and program instructions stored on at least one of the one or more storage devices.

An embodiment includes a computer system. The computer system includes one or more processors, one or more computer-readable memories, and one or more computer-readable storage devices, and program instructions stored on at least one of the one or more storage devices for execution by at least one of the one or more processors via at least one of the one or more memories.

### BRIEF DESCRIPTION OF THE DRAWINGS

Certain novel features believed characteristic of the invention are set forth in the appended claims. The invention itself, however, as well as a preferred mode of use, further objectives and advantages thereof, will best be understood by reference to the following detailed description of the illustrative embodiments when read in conjunction with the accompanying drawings, wherein:

FIG. 1 depicts a block diagram of a network of data processing systems in which illustrative embodiments may be implemented;

FIG. 2 depicts a block diagram of a data processing system in which illustrative embodiments may be implemented;

FIG. 3 depicts a block diagram of an example configuration for gravity based routing optimization for goods or data in accordance with an illustrative embodiment;

FIG. 4 depicts an example of gravity based routing optimization for goods or data in accordance with an illustrative embodiment;

FIG. 5 depicts a continued example of gravity based routing optimization for goods or data in accordance with an illustrative embodiment;

FIG. 6 depicts a flowchart of an example process for gravity based routing optimization for goods or data in accordance with an illustrative embodiment;

FIG. 7 depicts a cloud computing environment according to an embodiment of the present invention; and

FIG. 8 depicts abstraction model layers according to an embodiment of the present invention.

### DETAILED DESCRIPTION

The illustrative embodiments recognize that, once there are more than a few routing possibilities to analyze and select from, humans can no longer perform routing optimization effectively. In addition, humans often lack the time (e.g. when considering a destination of a charitable donation, or when streaming video data requires routing in real time) or expertise (e.g. in investing or supply chain management) to route data, goods, or money to the appropriate place at the appropriate time. Even when implemented on a computer, routing data, goods, or money to the appropriate place at the appropriate time is a complex mathematical problem, in which vectors modeling elements of a configuration are of such high dimensionality that presently used similarity measures are unhelpful in modeling routes. Thus, the illustrative embodiments recognize that there is an unmet need for a different route optimization technique, usable to route data, goods, or money in routings that best suit a router's needs.

The illustrative embodiments recognize that the presently available tools or solutions do not address these needs or provide adequate solutions for these needs. The illustrative embodiments used to describe the invention generally address and solve the above-described problems and other problems related to gravity based routing optimization for goods or data.

An embodiment can be implemented as a software application. The application implementing an embodiment can be configured as a modification of an existing goods or data routing system, as a separate application that operates in conjunction with an existing goods or data routing system, a standalone application, or some combination thereof.

Particularly, some illustrative embodiments provide a method that extracts a set of demand features from a first set of natural language documents describing a demand for an item, extracts a set of supply features from a second set of natural language documents describing a supply of the item, computes a correlation and a correlation trend between the set of demand features and the set of supply features, models, as a gravitational force, an attraction between the set of demand features and the set of supply features, and causes transporting of the item using a routing determined according to the attraction.

An embodiment receives a set of documents describing a supply and a demand of a good, data, or money. The documents may be in a structured format, in natural language form, or a combination. For example, a structured description for a portion of a supply chain might specify a set of input raw materials, with quantities and a date on which they are expected to arrive, a throughput of one or more factories capable of assembling the input raw materials into finished goods, and a demand for each of the finished goods forecasted for each month of the next year. As another example, content data in a structured format might include which users, having which predefined characteristics, watched which content, in which predefined categories, at which times and dates. As another example, investment data in a structured format might include a name, ticker symbol, and performance data over a set of predefined time periods for each potential investment. Some non-limiting examples of documents in natural language form are documents describing available investment options within an employer-provided retirement account program, content reviews (e.g., because highly-rated content is more likely to be requested), and documents resulting from a user's other online activities, such as interactions via a conversational system or chatbot, as well as social media, email, and text messages, on an opt-in basis, (for use in, e.g., determining a user's content, investment, or charitable donation interests. One embodiment receives additional documents based on a result of analysis of a first set of documents. For example, if analyzing a first set of documents determines that a user is interested in a particular set of causes or investment goals, the embodiment locates additional documents further describing charities involved in those particular causes or investments consistent with those particular investment goals.

An embodiment analyzes the set of documents and extracts a set of features describing a supply (supply features). Techniques are presently known to extract features from documents in both structured and natural language form. For example, one technique uses Latent Dirichlet Allocation (LDA), a type of statistical modeling, to classify text in a document into a particular topic or classification. An embodiment represents the set of supply features using a multidimensional numerical representation, also called a supply vector, Within the supply vector, each predefined feature corresponds to a dimension and the numerical range of each feature uses a common scale (e.g. 0-1).

An embodiment analyzes the demand set of documents and extracts a set of demand features in a manner described herein. An embodiment represents the set of demand features using a multidimensional numerical representation, also called a demand vector. The demand and supply vectors use the same format.

An embodiment computes a correlation between the set of demand features and the set of supply features. The correlation quantifies a relationship between the set of demand features and the set of supply features. Techniques for computing a statistical correlation between elements of two sets of data are presently available. For example, Pearson's correlation coefficient is the covariance of the two variables divided by the product of their standard deviations. An embodiment represents a correlation using a predefined dimension, or set of dimensions, of the demand and supply vectors, and adds correlation data to appropriate dimensions of the demand and supply vectors.

An embodiment computes a correlation trend corresponding to the correlation. The correlation trend quantifies a variation in the relationship between the set of demand features and the set of supply features over a time period. Techniques for computing a correlation trend are also presently available. One embodiment uses a correlation matrix to represent a variable's correlation with other variables. An embodiment represents a correlation trend using a predefined dimension, or set of dimensions, of the demand and supply vectors, and adds correlation trend data to appropriate dimensions of the demand and supply vectors.

An embodiment models an attraction between the demand and supply features as a gravitational force. In particular, as is known in physics, the gravitation force F between two masses, m₁ and m₂, is determined using the expression F=Gm₁m₂/r², where r is the distance between the two masses and G is a constant usually referred to as a gravitational constant.

To model an attraction between the demand and supply features, an embodiment uses a computation of homophily to replace m₁m₂ in the gravitational force expression. To compute homophily, one embodiment uses the expression h=1/d (demand vector, supply vector), in which h denotes homophily and d (demand vector, supply vector) denotes the distance between the two vectors. Mathematical techniques for computing the distance between two multidimensional vectors, for example a Hamming distance, are presently known. Other homophily computations are also possible and contemplated within the scope of the illustrative embodiments.

An embodiment also computes two distributions: one corresponding to a set of needs (e.g., housing, when funds are being routed to one or more charities), and another corresponding to an ability (e.g., of a particular charity) to supply each need. An embodiment computes a set of values, r₁, r₂, etc., in which a denotes an ability in the ability distribution, n denotes a need in the need distribution, tan h denotes the hyperbolic tangent function which converts any real value to a value in the range −1 to 1, and each r=tan h (a)−tan h (n). An embodiment squares each r in the set of values, r₁, r₂, etc., sums the result, and uses the result as r² in the gravitational force equation.

The resulting value of F represents an attraction (e.g. of goods, data, or money) from a source to a destination. Thus, an embodiment uses the resulting value of F to determine a routing from a source to a destination, and uses the routing to transport an item using the routing. For example, in the case of content, the routing might be from a central data center storing a piece of content to an edge device closest to a user or group of users modelled as likeliest to consume the content. As another example, in the case of investment or charity donation, the routing might be from a user's bank account to a charity modelled as most similar to the user's interests or an investment modelled as most similar to the user's investment goals. As a third example, in the case of goods, the routing might be from a source of the goods (e.g. a factory) to a location modelled as having the highest demand for the goods. (e.g. a warehouse in a particular city or a store in a particular neighborhood).

An embodiment extends the gravitational attraction model to model a change in attractiveness of sub-entities within an entity over time as gravitational flux. From physics, gravitational flux is the surface integral of a gravitational field over a closed surface, and is equal to −4πGM, where G denotes the same constant as in the gravitational force equation and M denotes the total mass enclosed within the closed surface. Here, M models the total amount of an item (e.g. goods, data, or money) a destination can accept. Thus, flux at a future time=−4πGM+(−4πGM)*(δγ/δm)*time, in which δγ/δm is the derivative of flux with respect to M. In addition, if portions of M are to be routed to one or more sub-entities within a parent entity, an embodiment computes a partial flux for each portion using the portion's M divided by the sum of all fluxes for all portions. The portion's M is determined from valuation of an item, for example as stored in a database manually entered by a human evaluator or accountant. Thus, each partial flux represents a modelled attractiveness of one sub-entity within a parent entity. An embodiment uses the partial fluxes to model a routing between sub-entities, each with different parents, that are similar to each other. Similarity of a portion's M to another portion's M is determined using any similarity measure, such as hamming, cartesian, and cosine similarity.

The manner of gravity based routing optimization for goods or data described herein is unavailable in the presently available methods in the technological field of endeavor pertaining to routing of goods or data. A method of an embodiment described herein, when implemented to execute on a device or data processing system, comprises substantial advancement of the functionality of that device or data processing system in extracting a set of demand features from a first set of natural language documents describing a demand for an item, extracting a set of supply features from a second set of natural language documents describing a supply of the item, computing a correlation and a correlation trend between the set of demand features and the set of supply features, modeling, as a gravitational force, an attraction between the set of demand features and the set of supply features, and causing transporting of the item using a routing determined according to the attraction.

The illustrative embodiments are described with respect to certain types of items, goods, data, money, documents, supply features, demand features, vectors, model components, measurements, devices, data processing systems, environments, components, and applications only as examples. Any specific manifestations of these and other similar artifacts are not intended to be limiting to the invention. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

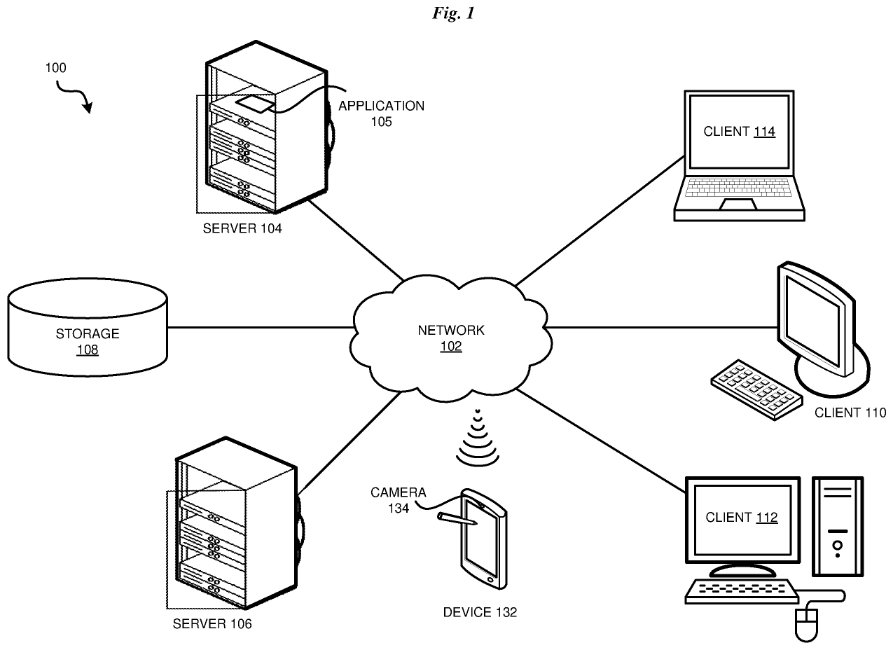

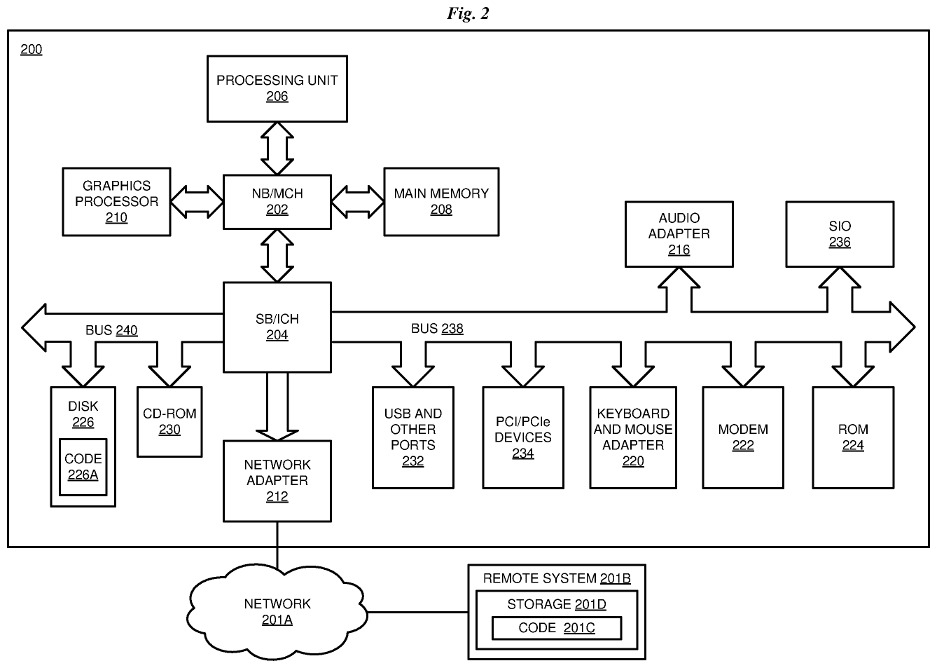

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

FIG. 1 depicts a block diagram of a network of data processing systems in which illustrative embodiments may be implemented. Data processing environment 100 is a network of computers in which the illustrative embodiments may be implemented. Data processing environment 100 includes network 102. Network 102 is the medium used to provide communications links between various devices and computers connected together within data processing environment 100. Network 102 may include connections, such as wire, wireless communication links, or fiber optic cables.

Clients or servers are only example roles of certain data processing systems connected to network 102 and are not intended to exclude other configurations or roles for these data processing systems. Server 104 and server 106 couple to network 102 along with storage unit 108. Software applications may execute on any computer in data processing environment 100. Clients 110, 112, and 114 are also coupled to network 102. A data processing system, such as server 104 or 106, or client 110, 112, or 114 may contain data and may have software applications or software tools executing thereon.

Only as an example, and without implying any limitation to such architecture, FIG. 1 depicts certain components that are usable in an example implementation of an embodiment. For example, servers 104 and 106, and clients 110, 112, 114, are depicted as servers and clients only as example and not to imply a limitation to a client-server architecture. As another example, an embodiment can be distributed across several data processing systems and a data network as shown, whereas another embodiment can be implemented on a single data processing system within the scope of the illustrative embodiments. Data processing systems 104, 106, 110, 112, and 114 also represent example nodes in a cluster, partitions, and other configurations suitable for implementing an embodiment.

Device 132 is an example of a device described herein. For example, device 132 can take the form of a smartphone, a tablet computer, a laptop computer, client 110 in a stationary or a portable form, a wearable computing device, or any other suitable device. Any software application described as executing in another data processing system in FIG. 1 can be configured to execute in device 132 in a similar manner. Any data or information stored or produced in another data processing system in FIG. 1 can be configured to be stored or produced in device 132 in a similar manner.

Application 105 implements an embodiment described herein. Application 105 executes in any of servers 104 and 106, clients 110, 112, and 114, and device 132.

Servers 104 and 106, storage unit 108, and clients 110, 112, and 114, and device 132 may couple to network 102 using wired connections, wireless communication protocols, or other suitable data connectivity. Clients 110, 112, and 114 may be, for example, personal computers or network computers.

In the depicted example, server 104 may provide data, such as boot files, operating system images, and applications to clients 110, 112, and 114. Clients 110, 112, and 114 may be clients to server 104 in this example. Clients 110, 112, 114, or some combination thereof, may include their own data, boot files, operating system images, and applications. Data processing environment 100 may include additional servers, clients, and other devices that are not shown.

In the depicted example, data processing environment 100 may be the Internet. Network 102 may represent a collection of networks and gateways that use the Transmission Control Protocol/Internet Protocol (TCP/IP) and other protocols to communicate with one another. At the heart of the Internet is a backbone of data communication links between major nodes or host computers, including thousands of commercial, governmental, educational, and other computer systems that route data and messages. Of course, data processing environment 100 also may be implemented as a number of different types of networks, such as for example, an intranet, a local area network (LAN), or a wide area network (WAN). FIG. 1 is intended as an example, and not as an architectural limitation for the different illustrative embodiments.

Among other uses, data processing environment 100 may be used for implementing a client-server environment in which the illustrative embodiments may be implemented. A client-server environment enables software applications and data to be distributed across a network such that an application functions by using the interactivity between a client data processing system and a server data processing system. Data processing environment 100 may also employ a service oriented architecture where interoperable software components distributed across a network may be packaged together as coherent business applications. Data processing environment 100 may also take the form of a cloud, and employ a cloud computing model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service.

With reference to FIG. 2, this figure depicts a block diagram of a data processing system in which illustrative embodiments may be implemented. Data processing system 200 is an example of a computer, such as servers 104 and 106, or clients 110, 112, and 114 in FIG. 1, or another type of device in which computer usable program code or instructions implementing the processes may be located for the illustrative embodiments.

Data processing system 200 is also representative of a data processing system or a configuration therein, such as data processing system 132 in FIG. 1 in which computer usable program code or instructions implementing the processes of the illustrative embodiments may be located. Data processing system 200 is described as a computer only as an example, without being limited thereto. Implementations in the form of other devices, such as device 132 in FIG. 1, may modify data processing system 200, such as by adding a touch interface, and even eliminate certain depicted components from data processing system 200 without departing from the general description of the operations and functions of data processing system 200 described herein.

In the depicted example, data processing system 200 employs a hub architecture including North Bridge and memory controller hub (NB/MCH) 202 and South Bridge and input/output (I/O) controller hub (SB/ICH) 204. Processing unit 206, main memory 208, and graphics processor 210 are coupled to North Bridge and memory controller hub (NB/MCH) 202. Processing unit 206 may contain one or more processors and may be implemented using one or more heterogeneous processor systems. Processing unit 206 may be a multi-core processor. Graphics processor 210 may be coupled to NB/MCH 202 through an accelerated graphics port (AGP) in certain implementations.

In the depicted example, local area network (LAN) adapter 212 is coupled to South Bridge and I/O controller hub (SB/ICH) 204. Audio adapter 216, keyboard and mouse adapter 220, modem 222, read only memory (ROM) 224, universal serial bus (USB) and other ports 232, and PCI/PCIe devices 234 are coupled to South Bridge and I/O controller hub 204 through bus 238. Hard disk drive (HDD) or solid-state drive (SSD) 226 and CD-ROM 230 are coupled to South Bridge and I/O controller hub 204 through bus 240. PCI/PCIe devices 234 may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE), serial advanced technology attachment (SATA) interface, or variants such as external-SATA (eSATA) and micro-SATA (mSATA). A super I/O (SIO) device 236 may be coupled to South Bridge and I/O controller hub (SB/ICH) 204 through bus 238.

Memories, such as main memory 208, ROM 224, or flash memory (not shown), are some examples of computer usable storage devices. Hard disk drive or solid state drive 226, CD-ROM 230, and other similarly usable devices are some examples of computer usable storage devices including a computer usable storage medium.

An operating system runs on processing unit 206. The operating system coordinates and provides control of various components within data processing system 200 in FIG. 2. The operating system may be a commercially available operating system for any type of computing platform, including but not limited to server systems, personal computers, and mobile devices. An object oriented or other type of programming system may operate in conjunction with the operating system and provide calls to the operating system from programs or applications executing on data processing system 200.

Instructions for the operating system, the object-oriented programming system, and applications or programs, such as application 105 in FIG. 1, are located on storage devices, such as in the form of code 226A on hard disk drive 226, and may be loaded into at least one of one or more memories, such as main memory 208, for execution by processing unit 206. The processes of the illustrative embodiments may be performed by processing unit 206 using computer implemented instructions, which may be located in a memory, such as, for example, main memory 208, read only memory 224, or in one or more peripheral devices.

Furthermore, in one case, code 226A may be downloaded over network 201A from remote system 201B, where similar code 201C is stored on a storage device 201D. in another case, code 226A may be downloaded over network 201A to remote system 201B, where downloaded code 201C is stored on a storage device 201D.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. In addition, the processes of the illustrative embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may comprise one or more buses, such as a system bus, an I/O bus, and a PCI bus. Of course, the bus system may be implemented using any type of communications fabric or architecture that provides for a transfer of data between different components or devices attached to the fabric or architecture.

A communications unit may include one or more devices used to transmit and receive data, such as a modem or a network adapter. A memory may be, for example, main memory 208 or a cache, such as the cache found in North Bridge and memory controller hub 202. A processing unit may include one or more processors or CPUs.

The depicted examples in FIGS. 1-2 and above-described examples are not meant to imply architectural limitations. For example, data processing system 200 also may be a tablet computer, laptop computer, or telephone device in addition to taking the form of a mobile or wearable device.

Where a computer or data processing system is described as a virtual machine, a virtual device, or a virtual component, the virtual machine, virtual device, or the virtual component operates in the manner of data processing system 200 using virtualized manifestation of some or all components depicted in data processing system 200. For example, in a virtual machine, virtual device, or virtual component, processing unit 206 is manifested as a virtualized instance of all or some number of hardware processing units 206 available in a host data processing system, main memory 208 is manifested as a virtualized instance of all or some portion of main memory 208 that may be available in the host data processing system, and disk 226 is manifested as a virtualized instance of all or some portion of disk 226 that may be available in the host data processing system. The host data processing system in such cases is represented by data processing system 200.

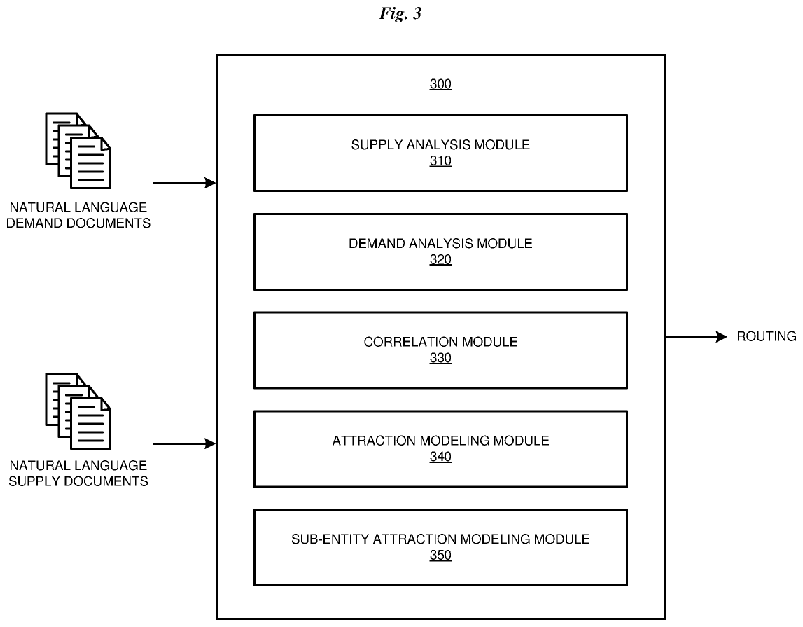

With reference to FIG. 3, this figure depicts a block diagram of an example configuration for gravity based routing optimization for goods or data in accordance with an illustrative embodiment. Application 300 is an example of application 105 in FIG. 1 and executes in any of servers 104 and 106, clients 110, 112, and 114, and device 132 in FIG. 1.

Application 300 receives a set of documents describing a supply and a demand of a good, data, or money. The documents may be in a structured format, in natural language form, or a combination. One implementation of application 300 receives additional documents based on a result of analysis of a first set of documents. For example, if analyzing a first set of documents determines that a user is interested in a particular set of causes or investment goals, the embodiment locates additional documents further describing charities involved in those particular causes or investments consistent with those particular investment goals.

Supply analysis module 310 analyzes the set of documents and extracts a set of features describing a supply (supply features). Module 310 represents the set of supply features using a multidimensional numerical representation, also called a supply vector, Within the supply vector, each predefined feature corresponds to a dimension and the numerical range of each feature uses a common scale (e.g. 0-1).

Demand analysis module 320 analyzes the demand set of documents and extracts a set of demand features in a manner described herein. Module 320 represents the set of demand features using a multidimensional numerical representation, also called a demand vector, The demand and supply vectors use the same format.

Correlation module 330 computes a correlation between the set of demand features and the set of supply features. The correlation quantifies a relationship between the set of demand features and the set of supply features. Module 330 represents a correlation using a predefined dimension, or set of dimensions, of the demand and supply vectors, and adds correlation data to appropriate dimensions of the demand and supply vectors. Module 330 also computes a correlation trend corresponding to the correlation. The correlation trend quantifies a variation in the relationship between the set of demand features and the set of supply features over a time period. Module 330 represents a correlation trend using a predefined dimension, or set of dimensions, of the demand and supply vectors, and adds correlation trend data to appropriate dimensions of the demand and supply vectors.

Attraction modeling module 340 models an attraction between the demand and supply features as a gravitational force. In particular, as is known in physics, the gravitation force F between two masses, m₁ and m₂, is determined using the expression F=Gm₁m₂/r², where r is the distance between the two masses and G is a constant usually referred to as a gravitational constant. To model an attraction between the demand and supply features, module 340 uses a computation of homophily to replace mime in the gravitational force expression. To compute homophily, one implementation of module 340 uses the expression h=1/d (demand vector, supply vector), in which h denotes homophily and d (demand vector, supply vector) denotes the distance between the two vectors. Module 340 also computes two distributions: one corresponding to a set of needs, and another corresponding to an ability to supply each need. Module 340 computes a set of values, r₁, r₂, etc., in which a denotes an ability in the ability distribution, n denotes a need in the need distribution, tan h denotes the hyperbolic tangent function which converts any real value to a value in the range −1 to 1, and each r=tan h (a)−tan h (n). Module 340 squares each r in the set of values, r₁, r₂, etc., sums the result, and uses the result as r² in the gravitational force equation.

The resulting value of F represents an attraction (e.g. of goods, data, or money) from a source to a destination. Thus, application 300 uses the resulting value of F to determine a routing from a source to a destination, and uses the routing to transport an item using the routing.

Sub-entity attraction modeling module 350 extends the gravitational attraction model to model a change in attractiveness of sub-entities within an entity over time as gravitational flux. From physics, gravitational flux is the surface integral of a gravitational field over a closed surface, and is equal to −4πGM, where G denotes the same constant as in the gravitational force equation and M denotes the total mass enclosed within the closed surface. Here, M models the total amount of an item (e.g. goods, data, or money) a destination can accept. Thus, flux at a future time=−4πGM+(−4πGM)*(δγ/δm)*time, in which δγ/δm is the derivative of flux with respect to M. In addition, if portions of M are to be routed to one or more sub-entities within a parent entity, module 350 computes a partial flux for each portion, as the flux computed using the portion's M divided by the sum of all fluxes for all portions. The portion's M is determined from valuation of an item, for example as stored in a database manually entered by a human evaluator or accountant. Thus, each partial flux represents a modelled attractiveness of one sub-entity within a parent entity. Module 350 also extends the gravitational attraction model to model a routing between sub-entities, each with different parents, that are similar to each other.

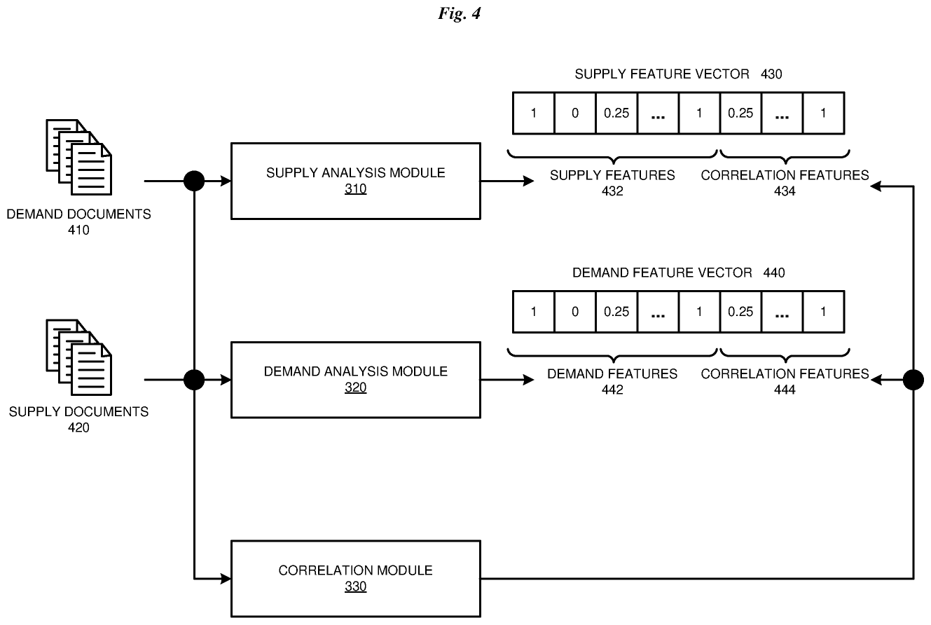

With reference to FIG. 4, this figure depicts an example of gravity based routing optimization for goods or data in accordance with an illustrative embodiment. The example can be executed using application 300 in FIG. 3. Supply analysis module 310, demand analysis module 320, and correlation module 330 are the same as supply analysis module 310, demand analysis module 320, and correlation module 330 in FIG. 3.

Application 300 receives demand documents 410 and supply documents 420. The documents may be in a structured format, in natural language form, or a combination. For example, a structured description for a portion of a supply chain might specify a set of input raw materials, with quantities and a date on which they are expected to arrive, a throughput of one or more factories capable of assembling the input raw materials into finished goods, and a demand for each of the finished goods forecasted for each month of the next year. As another example, content data in a structured format might include which users, having which predefined characteristics, watched which content, in which predefined categories, at which times and dates. As another example, investment data in a structured format might include a name, ticker symbol, and performance data over a set of predefined time periods for each potential investment. Some non-limiting examples of documents in natural language form are documents describing available investment options within an employer-provided retirement account program, content reviews (e.g., because highly-rated content is more likely to be requested), and documents resulting from a user's other online activities, such as interactions via a conversational system or chatbot, as well as social media, email, and text messages, on an opt-in basis, (for use in, e.g., determining a user's content, investment, or charitable donation interests.

Supply analysis module 310 analyzes the set of documents and extracts a set of features describing a supply (supply features). Module 310 represents the set of supply features using the supply features 432 section of supply feature vector 430, a multidimensional numerical representation. Within the supply vector, each predefined feature corresponds to a dimension and the numerical range of each feature uses a common scale (e.g. 0-1).

Demand analysis module 320 analyzes the demand set of documents and extracts a set of demand features in a manner described herein. An embodiment represents the set of demand features using the demand features 442 section of demand feature vector 440, a multidimensional numerical representation. Vectors 430 and 440 use the same format.

Correlation module 330 computes a correlation between the set of demand features and the set of supply features, and a correlation trend corresponding to the correlation. The results are stored in the correlation features 434 and 444 sections of vectors 430 and 440, respectively.

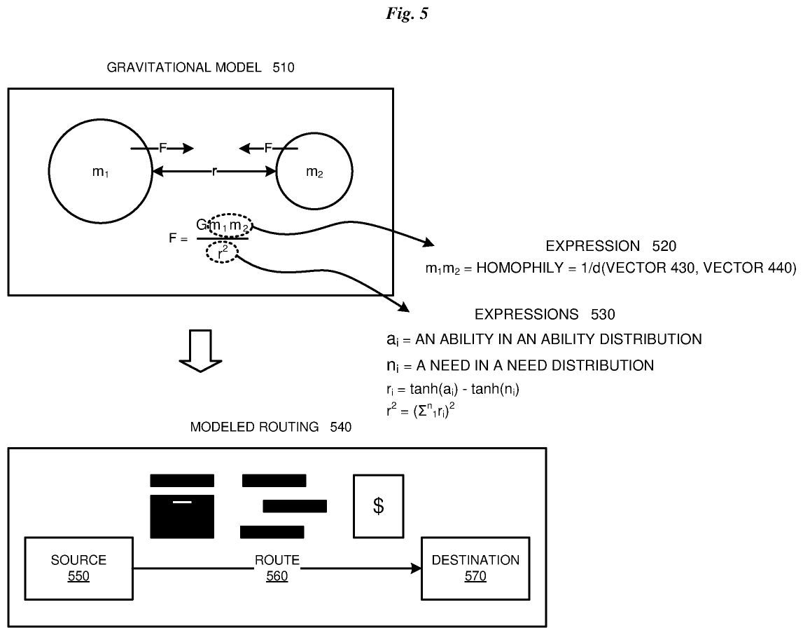

With reference to FIG. 5, this figure depicts a continued example of gravity based routing optimization for goods or data in accordance with an illustrative embodiment. Vectors 430 and 440 are the same as vectors 430 and 440 in FIG. 4.

Gravitation model 510 depicts models an attraction between the demand and supply features as a gravitational force between two masses, m₁ and m₂, using the expression F=Gm₁m₂/r², where r is the distance between the two masses and G is a constant usually referred to as a gravitational constant. To replace mime in the gravitational force expression, application 300 uses expression 520. To replace r² in the gravitational force equation, application 300 uses expressions 530.

The resulting value of F represents an attraction (e.g. of goods, data, or money) from a source to a destination. Modeled routing 540 depicts the result, in which application 300 has used the resulting value of F to determine route 560 from source 550 to destination 570, and uses the routing to transport an item, such as goods, data, or money, using route 560.

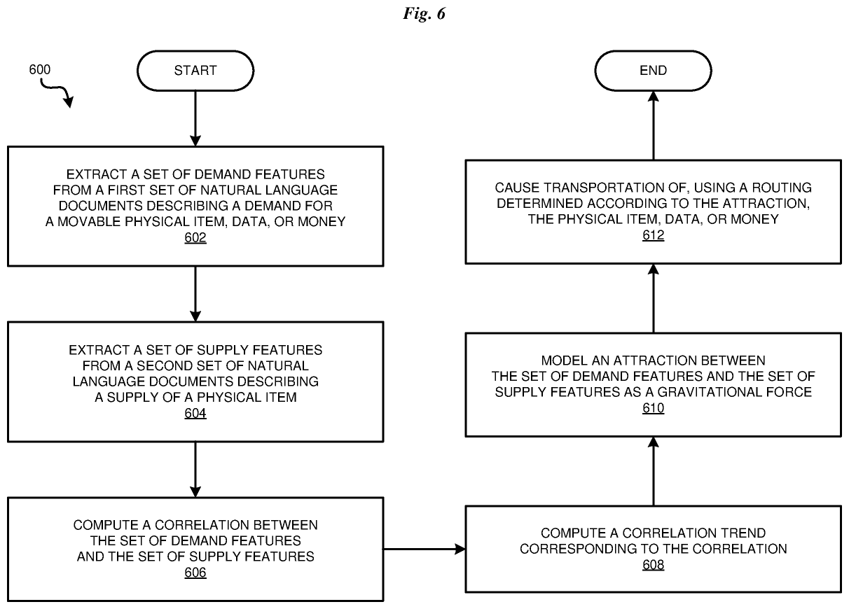

With reference to FIG. 6, this figure depicts a flowchart of an example process for gravity based routing optimization for goods or data in accordance with an illustrative embodiment. Process 600 can be implemented in application 300 in FIG. 3.

In block 602, the application extracts a set of demand features from a first set of natural language documents describing a demand for a movable physical item, data, or money. In block 604, the application extracts a set of supply features from a second set of natural language documents describing a supply of a physical item. In block 606, the application computes a correlation between the set of demand features and the set of supply features. In block 608, the application computes a correlation trend corresponding to the correlation. In block 610, the application models an attraction between the set of demand features and the set of supply features as a gravitational force. In block 612, the application causes transportation of, using a routing determined according to the attraction, the physical item, data, or money. Then the application ends.

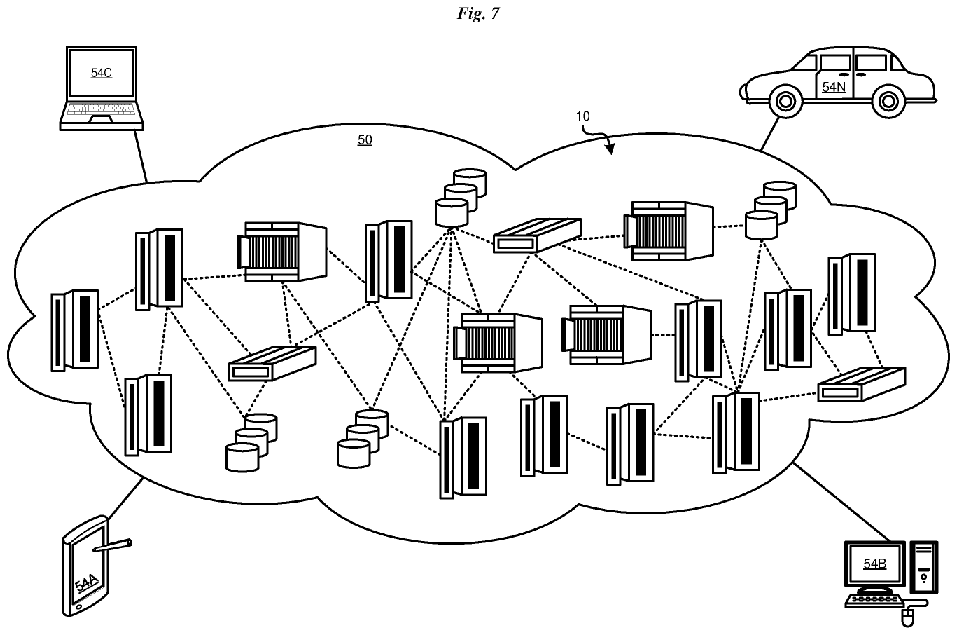

Referring now to FIG. 7, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N depicted are intended to be illustrative only and that computing nodes 10 and cloud computing environment 50 can communicate with any type of computerized device over any type of network and/or network addressable connection (e.g., using a web browser).

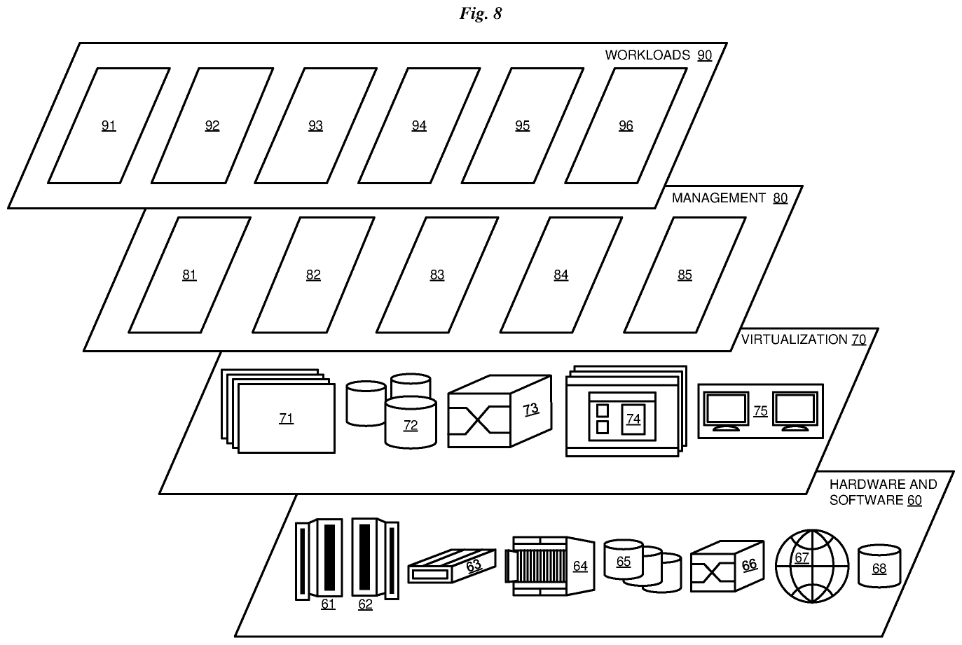

Referring now to FIG. 8, a set of functional abstraction layers provided by cloud computing environment 50 (FIG. 7) is shown. It should be understood in advance that the components, layers, and functions depicted are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and application selection based on cumulative vulnerability risk assessment 96.

Thus, a computer implemented method, system or apparatus, and computer program product are provided in the illustrative embodiments for gravity based routing optimization for goods or data and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer-implemented method comprising:
extracting, from a first set of natural language documents describing a demand for a movable physical item, a set of demand features;
extracting, from a second set of natural language documents describing a supply of the movable physical item, a set of supply features;
computing a correlation between the set of demand features and the set of supply features, the correlation quantifying a relationship between the set of demand features and the set of supply features;
computing a correlation trend corresponding to the correlation, the correlation trend quantifying a variation in the relationship between the set of demand features and the set of supply features over a time period;
modeling, as a gravitational force, using the correlation and the correlation trend, an attraction between the set of demand features and the set of supply features; and
causing transporting of, using a routing determined according to the attraction, the movable physical item.

2. The computer-implemented method of claim 1, further comprising:
generating, from the set of demand features, the correlation, and the correlation trend, a demand vector, the demand vector comprising a multidimensional numerical representation of the set of demand features.

3. The computer-implemented method of claim 1, further comprising:
generating, from the set of supply features, the correlation, and the correlation trend, a supply vector, the supply vector comprising a multidimensional numerical representation of the set of supply features.

4. The computer-implemented method of claim 1, wherein modeling the attraction between the set of demand features and the set of supply features comprises computing a homophily between the set of demand features and the set of supply features.

5. The computer-implemented method of claim 4, wherein the homophily comprises one divided by a distance between the set of demand features and the set of supply features.

6. The computer-implemented method of claim 1, wherein modeling the attraction between the set of demand features and the set of supply features comprises computing a difference between a need within a need distribution and an ability within an ability distribution.

7. A computer program product for gravity based routing, the computer program product comprising:
one or more computer readable storage media, and program instructions collectively stored on the one or more computer readable storage media, the stored program instructions comprising:
program instructions to extract, from a first set of natural language documents describing a demand for a movable physical item, a set of demand features;
program instructions to extract, from a second set of natural language documents describing a supply of the movable physical item, a set of supply features;
program instructions to compute a correlation between the set of demand features and the set of supply features, the correlation quantifying a relationship between the set of demand features and the set of supply features;
program instructions to compute a correlation trend corresponding to the correlation, the correlation trend quantifying a variation in the relationship between the set of demand features and the set of supply features over a time period;
program instructions to model, as a gravitational force, using the correlation and the correlation trend, an attraction between the set of demand features and the set of supply features; and
program instructions to cause transporting of, using a routing determined according to the attraction, the movable physical item.

8. The computer program product of claim 7, the stored program instructions further comprising:
program instructions to generate, from the set of demand features, the correlation, and the correlation trend, a demand vector, the demand vector comprising a multidimensional numerical representation of the set of demand features.

9. The computer program product of claim 7, the stored program instructions further comprising:
program instructions to generate, from the set of supply features, the correlation, and the correlation trend, a supply vector, the supply vector comprising a multidimensional numerical representation of the set of supply features.

10. The computer program product of claim 7, wherein modeling the attraction between the set of demand features and the set of supply features comprises computing a homophily between the set of demand features and the set of supply features.

11. The computer program product of claim 10, wherein the homophily comprises one divided by a distance between the set of demand features and the set of supply features.

12. The computer program product of claim 7, wherein modeling the attraction between the set of demand features and the set of supply features comprises computing a difference between a need within a need distribution and an ability within an ability distribution.

13. The computer program product of claim 7, wherein the stored program instructions are stored in the at least one of the one or more storage media of a local data processing system, and wherein the stored program instructions are transferred over a network from a remote data processing system.

14. The computer program product of claim 7, wherein the stored program instructions are stored in the at least one of the one or more storage media of a server data processing system, and wherein the stored program instructions are downloaded over a network to a remote data processing system for use in a computer readable storage device associated with the remote data processing system.

15. The computer program product of claim 7, wherein the computer program product is provided as a service in a cloud environment.

16. A computer system comprising one or more processors, one or more computer-readable memories, and one or more computer-readable storage media, and program instructions stored on at least one of the one or more storage media for execution by at least one of the one or more processors via at least one of the one or more memories, the stored program instructions comprising:
program instructions to extract, from a first set of natural language documents describing a demand for a movable physical item, a set of demand features;
program instructions to extract, from a second set of natural language documents describing a supply of the movable physical item, a set of supply features;
program instructions to compute a correlation between the set of demand features and the set of supply features, the correlation quantifying a relationship between the set of demand features and the set of supply features;
program instructions to compute a correlation trend corresponding to the correlation, the correlation trend quantifying a variation in the relationship between the set of demand features and the set of supply features over a time period;
program instructions to model, as a gravitational force, using the correlation and the correlation trend, an attraction between the set of demand features and the set of supply features; and
program instructions to cause transporting of, using a routing determined according to the attraction, the movable physical item.

17. The computer system of claim 16, the stored program instructions further comprising:
program instructions to generate, from the set of demand features, the correlation, and the correlation trend, a demand vector, the demand vector comprising a multidimensional numerical representation of the set of demand features.

18. The computer system of claim 16, the stored program instructions further comprising:
program instructions to generate, from the set of supply features, the correlation, and the correlation trend, a supply vector, the supply vector comprising a multidimensional numerical representation of the set of supply features.

19. The computer system of claim 16, wherein modeling the attraction between the set of demand features and the set of supply features comprises computing a homophily between the set of demand features and the set of supply features.

20. The computer system of claim 16, wherein the homophily comprises one divided by a distance between the set of demand features and the set of supply features.
